(19) United States
(12) Patent Application Publication
(10) Pub. No.: US 2025/0005074 A1
(43) Pub. Date: Jan. 2, 2025

(54) SYSTEM AND METHOD FOR RETRIEVING RELEVANT OUT-OF-DOMAIN EXAMPLES TO INSPIRE VISUAL CONTENT CREATION

(71) Applicant: TOYOTA RESEARCH INSTITUTE, INC., Los Altos, CA (US)

(72) Inventors: Matthew Kyung-Soo HONG, Mountain View, CA (US); Yin-Ying CHEN, San Jose, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/345,933

(22) Filed: Jun. 30, 2023

(51) Int. Cl. G06F 16/535; G06F 16/953; G06V 20/70

(52) U.S. Cl. CPC G06F 16/535; G06F 16/953; G06V 20/70

(57) ABSTRACT

A method for a visual content search and creation is described. The method includes detecting multiple objects in an image displayed on a user's workspace. The method also includes attaching a representative text label to detected objects in the image displayed on the user's workspace. The method further includes inferring both a high-level domain and a low-level domain from the representative text labels attached to the detected objects. The method also includes retrieving visual content according to the high-level domain and the low-level domain. The method further includes displaying out-of-domain visual content filtered from the retrieved visual content through a user interface in response to user-controlled filtering of unwanted visual content.

### BACKGROUND

### Field

Certain aspects of the present disclosure generally relate to machine assisted cognition and, more particularly, to a system and method for retrieving relevant out-of-domain examples to inspire visual content creation.

### Background

Visual content creators may utilize image curation tools to provide an online platform for creating and highlighting their creative work. For example, image curation tools such as PINTEREST® and BEHANCE® are the de facto standard tools used by designers to inspire their work. Nevertheless, exploring a design space involves a manual and aimless process, which is not provided by these image creation tools. In practice, visual content creators first begin their creative process (e.g., concept sketches) by aimlessly searching or scrolling through images in diverse topics (e.g., fashion, architecture, product design, etc.). Unfortunately, this image searching/scrolling does not expose them to a diverse set of image content that is often outside of their primary domain of expertise. This searching/scrolling process is followed by iteratively narrowing down the topic, scope, and focus of the search as the visual content creators increase the fidelity of their designs.

A visual content creation tool for augmenting the visual content creation process using, for example, an artificial intelligence (AI) design assistant that automatically adapts to the designer's concept sketch by injecting relevant out-of-domain inspirational visual content into the visual content creator's workspace digital or physical workspace, including but not limited to web, software, augmented and virtual reality environments, and physical surface, is desired.

### SUMMARY

A method for a visual content search and creation is described. The method includes detecting multiple objects in an image displayed on a user's workspace. The method also includes attaching a representative text label to detected objects in the image displayed on a user's workspace. The method further includes inferring both a high-level domain and a low-level domain from the representative text labels attached to the detected objects. The method also includes retrieving visual content according to the high-level domain and the low-level domain. The method further includes displaying out-of-domain visual content filtered from the retrieved visual content through a user interface in response to user-controlled filtering of unwanted visual content.

A non-transitory computer-readable medium having program code recorded thereon for a visual content creation is described. The program code is executed by a processor. The non-transitory computer-readable medium includes program code to detect multiple objects in an image displayed on a user's workspace. The non-transitory computer-readable medium also includes program code to attach a representative text label to detected objects in the image displayed on the user's workspace. The non-transitory computer-readable medium further includes program code to infer both a high-level domain and a low-level domain from the representative text labels attached to the detected objects. The non-transitory computer-readable medium also includes program code to retrieve visual content according to the high-level domain and the low-level domain. The non-transitory computer-readable medium further includes program code to display out-of-domain visual content filtered from the retrieved visual content through a user interface in response to user-controlled filtering of unwanted visual content.

A system for a visual content creation is described. The system includes an image/object detection module to detect multiple objects in an image displayed on the user's workspace. The system also includes an object labeling module to attach a representative text label to detected objects in the image displayed on the user's workspace. The system further includes a label domain inference module to infer both a high-level domain and a low-level domain from the representative text labels attached to the detected objects. The system also includes a visual content retrieval module to retrieve visual content according to the high-level domain and the low-level domain. The system further includes a user interface module to display out-of-domain visual content filtered from the retrieved visual content through a user interface in response to user-controlled filtering of unwanted visual content.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC) of a visual content creation system, in accordance with aspects of the present disclosure.

FIG. 2 is a block diagram illustrating an exemplary software architecture that may modularize artificial intelligence (AI) functions for a visual content creation system, according to aspects of the present disclosure.

FIG. 3 is a diagram illustrating a hardware implementation for a visual content creation system, according to aspects of the present disclosure.

FIG. 4 is a diagram illustrating a user interface for a content creation system, according to aspects of the present disclosure.

FIG. 5 is a process flow diagram illustrating a method for a content creation system, according to aspects of the present disclosure. [FIG. 5 will be completed after claim language approval.]

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

While image curation tools such as PINTEREST® and BEHANCE® provide de facto standard tools used by designers to inspire their work, exploring the design space involves a very manual and aimless process. For example, designers first begin their creative process (e.g., concept sketches) by aimlessly searching or scrolling through images in diverse topics (e.g., fashion, architecture, product design, etc.). Often, these diverse topics are outside of the primary domain of expertise of the designer. This searching and scrolling process continues and iteratively narrows down the topic, scope, and focus of the designers' search as they increase the fidelity of their designs.

For example, consider the following scenario. A smartphone case designer scrolls through assorted designs for aluminum cases (e.g., suitcases, luggage cases, laptop cases, etc.), then becomes inspired by an aluminum watch crown. The designer starts a focused search for watch crowns while creating sketches for multiple variations of aluminum smartphone cases inspired by the watch crown. Nevertheless, the designer desires help in deciding which ribbed pattern is more aesthetically pleasing for a smartphone. The designer continues the search for ribbed patterned products outside of watches and adds the final changes that are partially inspired by ribbed panels in wooden furniture.

The above example illustrates a process that can be augmented using an artificial intelligence (AI) design assistant that automatically adapts to the designer's concept sketch by injecting relevant out-of-domain inspirational visual content into the designer's workspace. By contrast, existing state of the art visual search systems (e.g., Google Reverse Image Search) are optimized for retrieving and displaying perceptually similar images, in which features such as color saturation is overrepresented in the search results. These results, while promising, do not align with designers' needs for exploring similar inspirational content that often transcend perceptual features (e.g., gold, ribbed) and a particular domain (e.g., jewelry).

On the other hand, image curation tools such as PINTEREST® and BEHANCE® support people's visual exploration of the design space by allowing them to browse the breadth of images that are returned based on keyword matches or their previous interactions with curated designs. For designers, cross-pollination of these images across diverse domains serve as inspiration for creating new visual content (e.g., 2D, 3D, video). Nevertheless, most images displayed for the users are curated based on engagement and collaborative filtering, thus posing risk for bias and design fixation.

To this end, retrieving images based on both perceptual and functional similarity, as well as ensuring designers' exposure to diverse out-of-domain examples, promises a systematic approach to exploring inspirational visual content that aligns with the designers' needs. Some aspects of the present disclosure are directed to addressing a desire for adaptive visual inspiration generation tools that retrieve and display functionally and perceptually similar visual content that correspond to designers' specified scope in an image content within their workspace. In various aspects of the present disclosure, a visual content creation system detects multiple objects in a given image, attaches a representative text label, and infers a high-level domain (e.g., automotive, fashion, architecture, etc.) and a low-level domain (e.g., automotive interior, automotive exterior) from the representative text label by looking at higher-level words from a lexical ontology as discussed above. This content creation system provides an interface that enables users to turn off certain word tags to filter unwanted inspirations.

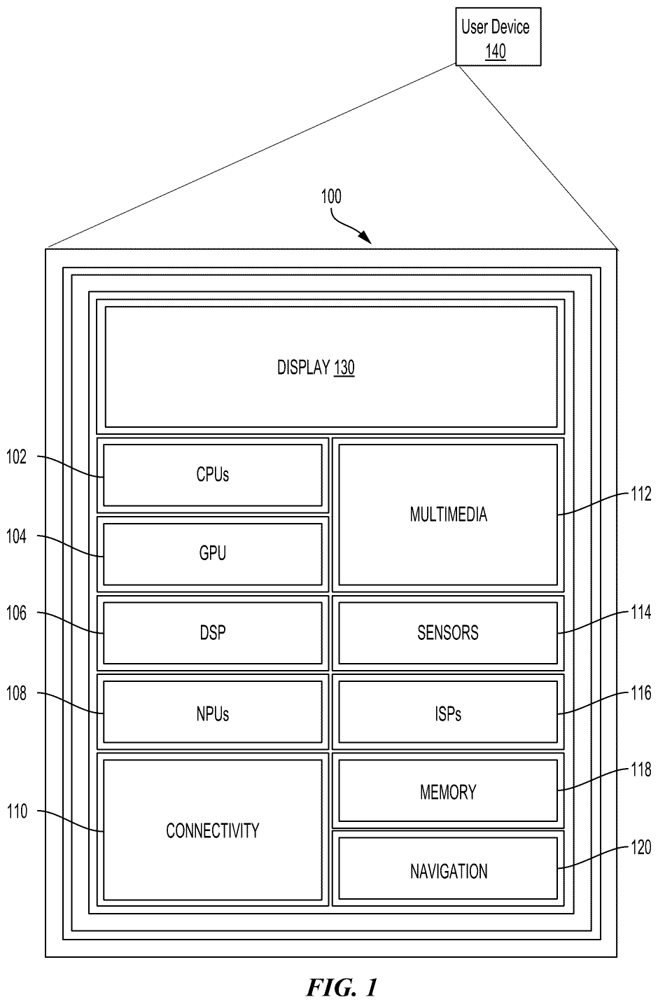

FIG. 1 illustrates an example implementation of the aforementioned system and method for a visual content creation system using a system-on-a-chip (SOC) 100, according to aspects of the present disclosure. The SOC 100 may include a single processor or multi-core processors (e.g., a central processing unit (CPU) 102), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, select a control action, according to the display 130 illustrating a view of a user device.

In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system. The SOC 100 may be based on an Advanced Risc Machine (ARM) instruction set or the like. In another aspect of the present disclosure, the SOC 100 may be a server computer in communication with a user device 140. In this arrangement, the user device 140 may include a processor and other features of the SOC 100.

In this aspect of the present disclosure, instructions loaded into a processor (e.g., CPU 102) or the NPU 108 may include code to provide a visual content creation system for augmenting the visual content creation process to adapt a designer's concept sketch by injecting relevant out-of-domain inspirational visual content into a visual content creator's workspace. The instructions loaded into a processor (e.g., NPU 108) may also include code to detect multiple objects in an image displayed on a user's workspace. The instructions loaded into the processor (e.g., NPU 108) may also include code to attach a representative text label to detected objects in the image displayed on the user's workspace. The instructions loaded into the processor (e.g., NPU 108) may also include code to infer both a high-level domain and a low-level domain from the representative text labels attached to the detected objects. The instructions loaded into the processor (e.g., NPU 108) may also include code to retrieve visual content according to the high-level domain and the low-level domain. The instructions loaded into the processor (e.g., NPU 108) may also include code to display out-of-domain visual content filtered from the retrieved visual content through a user interface in response to user-controlled filtering of unwanted visual content.

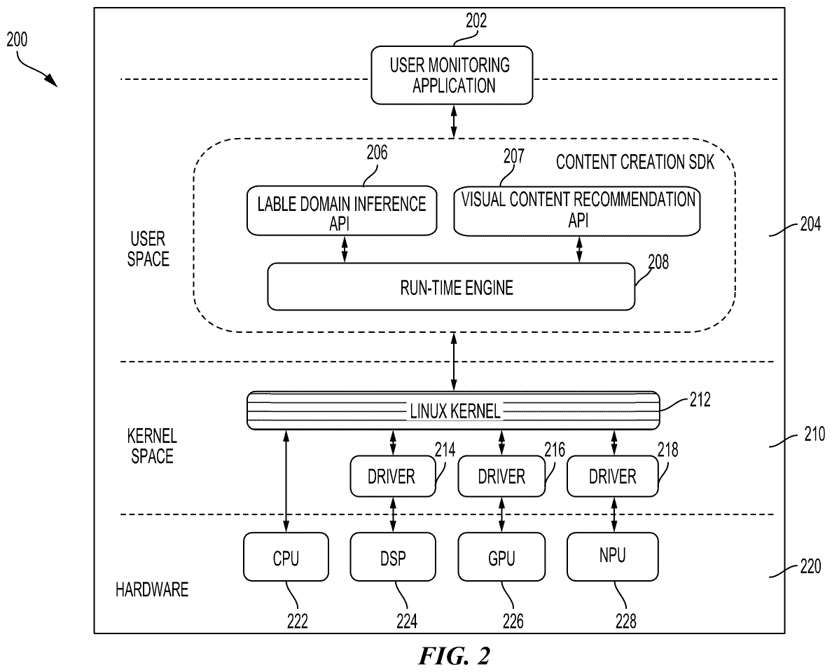

FIG. 2 is a block diagram illustrating a software architecture 200 that may modularize artificial intelligence (AI) functions for a visual content creation system, according to aspects of the present disclosure. Using the architecture, a user monitoring application 202 may be designed such that it may cause various processing blocks of an SOC 220 (for example a CPU 222, a DSP 224, a GPU 226, and/or an NPU 228) to perform supporting computations during run-time operation of the user monitoring application 202. FIG. 2 describes the software architecture 200 for a visual content creation system. It should be recognized that the visual content creation system is not limited to any specific information. According to aspects of the present disclosure, the user monitoring and the visual content creation functionality is applicable to any type of information access activity.

The user monitoring application 202 may be configured to call functions defined in a user space 204 that may, for example, provide visual content creation services. The user monitoring application 202 may make a request for compiled program code associated with a library defined in an image domain inference application programming interface (API) 206. The label domain inference API 206 is configured to infer both a high-level domain and a low-level domain from representative text labels attached to detected objects in an image displayed on the user's workspace.

In response, compiled program code of a visual content recommendation API 207 is configured to retrieve visual content according to the high-level domain and the low-level domain. Additionally, the visual content recommendation API 207 is configured to continue to display out-of-domain visual content filtered from the retrieved visual content through a user interface in response to user-controlled filtering of unwanted visual content. In some aspects of the present disclosure, the visual content recommendation API 207 augments the visual content creation process to adapt a designer's concept sketch by injecting relevant out-of-domain inspirational visual content into a visual content creator's workspace.

A run-time engine 208, which may be compiled code of a run-time framework, may be further accessible to the user monitoring application 202. The user monitoring application 202 may cause the run-time engine 208, for example, to take actions for recommendations of alternatives to inject out-of-domain inspirational visual content. In response to recommendation of visual content, the run-time engine 208 may in turn send a signal to an operating system 210, such as a Linux Kernel 212, running on the SOC 220. FIG. 2 illustrates the Linux Kernel 212 as software architecture for a visual content creation system. It should be recognized, however, that aspects of the present disclosure are not limited to this exemplary software architecture. For example, other kernels may provide the software architecture to support the visual content creation functionality.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228 if present.

As noted above, a visual content creation process can be augmented using an artificial intelligence (AI) design assistant that automatically adapts to the designer's concept sketch by injecting relevant out-of-domain inspirational visual content into the designer's workspace. By contrast, existing state of the art visual search systems (e.g., Google Reverse Image Search) are optimized for retrieving and displaying perceptually similar images, in which features such as color saturation is overrepresented in the search results. These results, while promising, do not align with designers' needs for exploring similar inspirational content that often transcend perceptual features (e.g., gold, ribbed) and a particular domain (e.g., jewelry).

On the other hand, image curation tools such as PINTEREST and BEHANCE support people's visual exploration of the design space by allowing them to browse the breadth of images that are returned based on keyword matches or their previous interactions with curated designs. For designers, cross-pollination of these images across diverse domains serve as inspiration for creating new visual content (e.g., 2D, 3D, video). Nevertheless, most images displayed for the users are curated based on engagement and collaborative filtering, thus posing risk for bias and design fixation. To this end, retrieving images based on both perceptual and functional similarity, as well as ensuring designers' exposure to diverse out-of-domain examples, promises a systematic approach to exploring inspirational visual content that aligns with designers' needs.

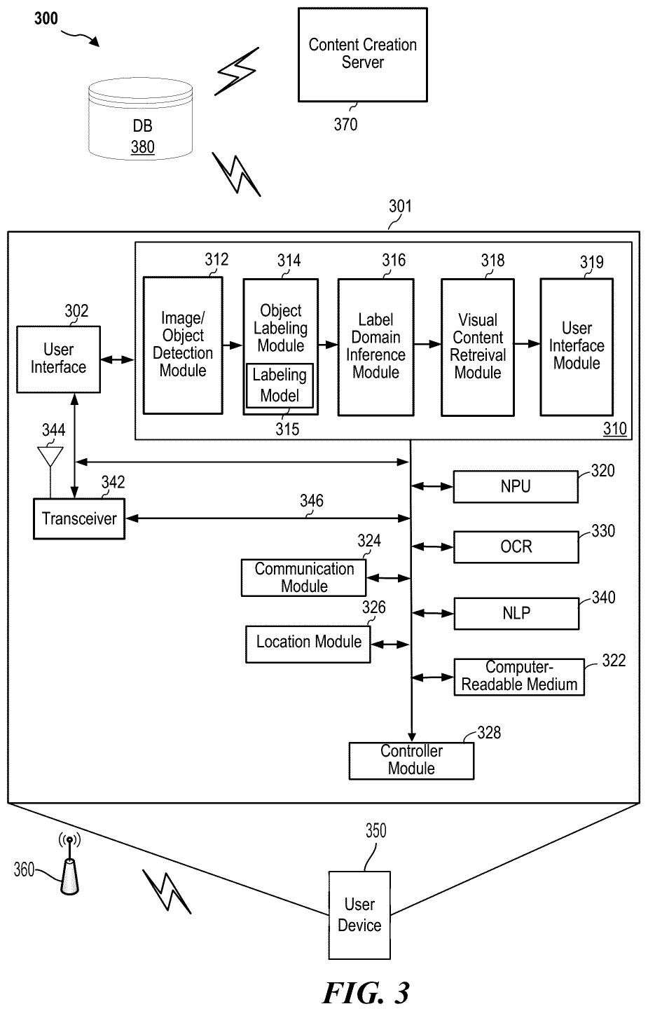

Various aspects of the present disclosure are directed to addressing a desire for adaptive visual inspiration generation tools that retrieve and display functionally and perceptually similar visual content that correspond to designers' specified scope in an image content within their workspace. In various aspects of the present disclosure, a visual content creation system detects multiple objects in a given image, attaches a representative text label, and infers a high-level domain (e.g., automotive, fashion, architecture, etc.) and a low-level domain (e.g., automotive interior, automotive exterior) from the representative text label by looking at higher-level words from a lexical ontology as discussed above. This content creation system provides an interface that enables users to turn off certain word tags to filter unwanted inspirations, for example, as shown in FIG. 3.

FIG. 3 is a diagram illustrating a hardware implementation for a visual content creation system 300, according to aspects of the present disclosure. The visual content creation system 300 may be configured to provide visual content creation assistance to a user based on out-of-domain visual content suggestions. The visual content creation system 300 is configured to augment the visual content creation process by adapting a designer's concept sketch by injecting relevant out-of-domain inspirational visual content into a visual content creator's workspace. In various aspects of the present disclosure, the visual content creation system 300 is configured to detect multiple objects in an image displayed on the user's workspace. The visual content creation system 300 is also configured to attach a representative text label to detected objects in the image displayed on the user's workspace. The visual content creation system 300 is further configured to infer both a high-level domain and a low-level domain from the representative text labels attached to the detected objects. The visual content creation system 300 is also configured to retrieve visual content according to the high-level domain and the low-level domain. The visual content creation system 300 is also configured to display out-of-domain visual content filtered from the retrieved visual content through a user interface in response to user-controlled filtering of unwanted visual content.

The visual content creation system 300 includes a user monitoring system 301 and a visual content creation server 370 in this aspect of the present disclosure. The user monitoring system 301 may be a component of a user device 350. The user device 350 may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a Smartbook, an Ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a global positioning system device, or any other suitable device that is configured to communicate via a wireless or wired medium.

The visual content creation server 370 may connect to the user device 350 for monitoring images displayed on the user's workspace to provide visual content creation assistance to a user by recommending out-of-domain visual content. For example, the visual content creation server 370 may detect multiple objects in an image displayed on the user's workspace. The visual content creation server 370 may also attach a representative text label to detected objects in the image displayed on the user's workspace. Additionally, the visual content creation server 370 may also infer both a high-level domain and a low-level domain from the representative text labels attached to the detected objects of the image. The visual content creation server 370 may retrieve visual content according to the high-level domain and the low-level domain. The visual content creation server 370 may also display out-of-domain visual content filtered from the retrieved visual content through a user interface in response to user-controlled filtering of unwanted visual content.

The user monitoring system 301 may be implemented with an interconnected architecture, represented by an interconnect 346, which may be implemented as a controller area network (CAN). The interconnect 346 may include any number of point-to-point interconnects, buses, and/or bridges depending on the specific application of the user monitoring system 301 and the overall design constraints. The interconnect 346 links together various circuits including one or more processors and/or hardware modules, represented by a user interface 302, a user activity module 310, a neural network processor (NPU) 320, a computer-readable medium 322, a communication module 324, a location module 326, a controller module 328, an optical character recognition (OCR) block 330, and a natural language processor (NLP) 340. The interconnect 346 may also link various other circuits such as timing sources, peripherals, voltage regulators, and power management circuits, which are well known in the art, and therefore, will not be described any further.

The user monitoring system 301 includes a transceiver 342 coupled to the user interface 302, the user activity module 310, the NPU 320, the computer-readable medium 322, the communication module 324, the location module 326, the controller module 328, the OCR 330, and NLP 340. The transceiver 342 is coupled to an antenna 344. The transceiver 342 communicates with various other devices over a transmission medium. For example, the transceiver 342 may receive commands via transmissions from a user. In this example, the transceiver 342 may receive/transmit information for the user activity module 310 to/from connected devices within the vicinity of the user device 350.

The user monitoring system 301 includes the NPU 320, the OCR 330, and the NLP 340 coupled to the computer-readable medium 322. The NPU 320, the OCR 330, and NLP 340 performs processing, including the execution of software stored on the computer-readable medium 322 to provide a neural network model for user monitoring and statistical data clarification functionality according to the present disclosure. The software, when executed by the NPU 320, the OCR 330 and the NLP 340, causes the user monitoring system 301 to perform the various functions described for presenting analogies to clarify statistical data presented to the user through the user device 350, or any of the modules (e.g., 310, 324, 326, and/or 328). The computer-readable medium 322 may also be used for storing data that is manipulated by the OCR 330 and the NLP 340 when executing the software to analyze user communications.

The location module 326 may determine a location of the user device 350. For example, the location module 326 may use a global positioning system (GPS) to determine the location of the user device 350. The location module 326 may implement a dedicated short-range communication (DSRC)-compliant GPS unit. A DSRC-compliant GPS unit includes hardware and software to make the user device 350 and/or the location module 326 compliant with the following DSRC standards, including any derivative or fork thereof: EN 12253:2004 Dedicated Short-Range Communication—Physical layer using microwave at 5.8 GHz (review); EN 12795:2002 Dedicated Short-Range Communication (DSRC)-DSRC Data link layer: Medium Access and Logical Link Control (review); EN 12834:2002 Dedicated Short-Range Communication-Application layer (review); EN 13372:2004 Dedicated Short-Range Communication (DSRC)-DSRC profiles for RTTT applications (review); and EN ISO 14906:2004 Electronic Fee Collection-Application interface.

The communication module 324 may facilitate communications via the transceiver 342. For example, the communication module 324 may be configured to provide communication capabilities via different wireless protocols, such as 5G new radio (NR), Wi-Fi, long term evolution (LTE), 4G, 3G, etc. The communication module 324 may also communicate with other components of the user device 350 that are not modules of the user monitoring system 301. The transceiver 342 may be a communications channel through a network access point 360. The communications channel may include DSRC, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

The user monitoring system 301 also includes the OCR 330 and the NLP 340 to automatically detect multiple objects in an image displayed on the user's workspace. The user monitoring system 301 may follow a process to detect and determine whether the user accesses creative content. When the user curates images, the user monitoring system 301 utilizes the OCR 330 and/or the NLP 340 to attach a representative text label to detected objects in the image displayed on the user's workspace.

The user activity module 310 may be in communication with the user interface 302, the NPU 320, the computer-readable medium 322, the communication module 324, the location module 326, the controller module 328, the OCR 330, the NLP 340, and the transceiver 342. In one configuration, the user activity module 310 monitors communications from the user interface 302. The user interface 302 may monitor user communications to and from the communication module 324. According to aspects of the present disclosure, the OCR 330 and the NLP 340 automatically detect images displayed on the user's workspace and may use computer vision object detection and instance segmentation techniques to automatically detect the objects in the image to enable text label attachment.

As shown in FIG. 3, the user activity module 310 includes an image/object detection module 312, an object labeling module 314, a label domain inference module 316, a visual content retrieval module 318, and a user interface module 319. The image/object detection module 312, the object labeling module 314, the label domain inference module 316, the visual content retrieval module 318, may be components of a same or different artificial neural network, such as a deep convolutional neural network (CNN). The user activity module 310 is not limited to a CNN. The user activity module 310 monitors and analyzes images displayed on the user's workspace from the user interface 302.

This configuration of the user activity module 310 includes the image/object detection module 312 configured to detect multiple objects in an image displayed on a user's workspace. In some aspects of the present disclosure, the image/object detection module 312 uses the OCR 330 and the NLP 340 to determine images displayed on the user's workspace by the user through the user interface 302. In some aspects of the present disclosure, the image/object detection module 312 assesses content accessed by the user to determine a content of the image and objects displayed on the user's workspace.

In various aspects of the present disclosure, the user activity module 310 includes an object labeling module 314 configured to attach a representative text label for each detected object in an image displayed on the user's workspace. In some aspects of the present disclosure, the object labeling module 314 includes a labeling model 315 that detects multiple objects in a given image, then attaches a representative text label for each detected object. In some aspects of the present disclosure, the labeling model 315 is trained to provide a text-image joint embedding to enable object identification and/or text label assignment. In some aspects of the present disclosure, bounding boxes and/or unique boundaries are drawn around the detected objects in the image displayed on the user's workspace by the user and displayed through the user interface 302.

In this example, the user activity module 310 also includes a label domain inference module 316 configured to infer both a high-level domain and a low-level domain from the representative text labels attached to the detected objects of the image. For example, the label domain inference module 316 may infer a high-level domain (e.g., automotive, fashion, architecture, etc.) and a low-level domain (e.g., automotive interior, automotive exterior) from the representative text label by looking at higher-level words from a lexical ontology. In some aspects of the present disclosure, the labeling model 315 uses a tuned natural language processing algorithm (e.g., using the NLP 340) to determine higher-level words from a lexical ontology of content displayed on the user's workspace. The label domain inference module 316 may be implemented using a tuned natural language processing algorithm, such as a lexical ontology approach and/or sentiment analysis.

Additionally, the user activity module 310 includes the visual content retrieval module 318 that is configured to retrieve visual content according to the high-level domain and the low-level domain. In some aspects of the present disclosure, the visual content retrieval module 318 is implemented using a search engine that retrieves and displays visual content (e.g., in a 3×3 grid) based on perceptual and functional similarity to the target image specified by a user. For example, selecting an A/C vent bounding box in an image of a car's interior by the user could trigger a search engine to retrieve and display similar out-of-domain examples that serve the purpose of an air vent and also resemble the physical appearance of a vent used for other purposes (e.g., sunshade—from home interior domain).

As shown in FIG. 3, the user activity module 310 further includes the user interface module 319 configured to display out-of-domain visual content filtered from the retrieved visual content through a user interface in response to user-controlled filtering of unwanted visual content. In some aspects of the present disclosure, the user interface module 319 allows users to select from suggested images in a grid to trigger a search query that would retrieve and display images similar to the ones selected. In various aspects of the present disclosure, the user interface module 319 enables the user to specify a region within the bounding box that should be included or ignored in the search. For example, lassoing around a vent alone instead of the entire component that includes the control wheel should trigger a search for the vent, effectively acting as a visual search filter. Optionally, the user interface module 319 (e.g., in case the detected objects in an image do not correspond to the designer's object of interest) enables specifying and selecting a customized region (e.g., lasso) in the visual concept for which the designer intends to retrieve relevant out-of-domain inspirational content.

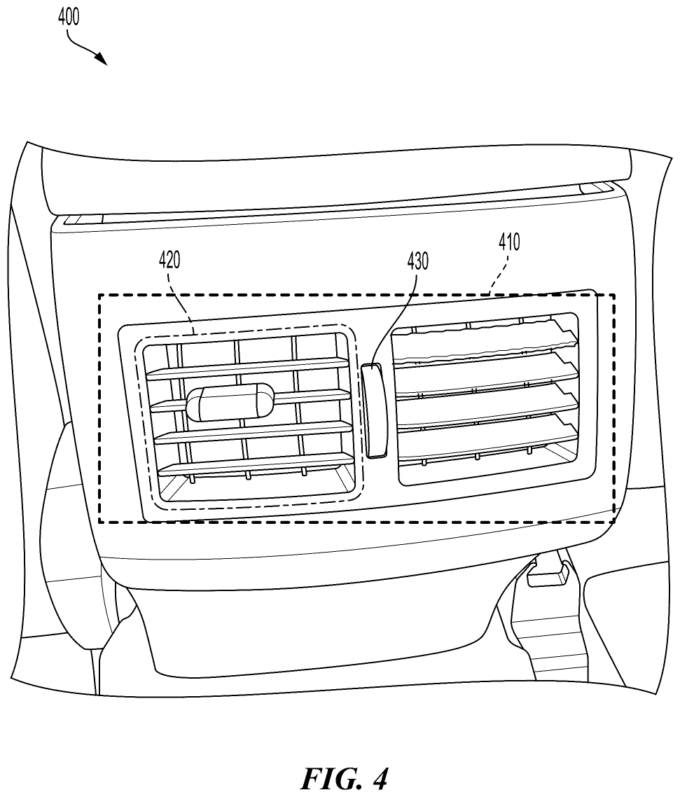

In some aspects of the present disclosure, the user interface module 319 is configured for filtering and specifying desired visual content via text. For example, the user interface module may display word tags representing different domains (e.g., aerospace, automotive, etc.) derived from the text-image joint embedding with the images using the label domain inference module 316. Additionally, the user interface module 319 enables users to turn off certain word tags to filter unwanted inspirations. The user interface module 319 also includes a filter for specifying whether the users want to see functionally or perceptually relevant visual content, for example, as shown in FIG. 4.

In some aspects of the present disclosure, the user activity module 310 may be implemented and/or work in conjunction with the visual content creation server 370. In one configuration, a database (DB) 380 stores data related to curated images/objects as well as previously curated images/objects, which may be displayed as output through the user interface 302. In some aspects of the present disclosure, the visual content creation system 300 may be implemented as a web browser plugin. In other aspects of the present disclosure, the visual content creation server 370 provides an offline application that scans content viewed through the user interface 302. In other aspects of the present disclosure, the visual content creation system 300 may by implemented as a mobile application that augments the visual content creation process by adapting a designer's concept sketch by injecting relevant out-of-domain inspirational visual content into the user interface 302, for example, as shown in FIG. 4.

FIG. 4 is a diagram illustrating a user interface for a content creation system, according to aspects of the present disclosure. As in FIG. 4, a user interface displays a visual content image 400 (e.g., in a 3×3 grid) retrieved by a search engine based on perceptual and functional similarity to a target image specified by a user. For example, user selection of an A/C vent bounding box 410 in the visual content image 400 of a car's interior could trigger the search engine to retrieve and display similar out-of-domain examples that serve the purpose of an air vent and also resemble the physical appearance of a vent used for other purposes (e.g., sunshade—from home interior domain).

For example, as shown in FIG. 3, the user interface module 319 is configured to display out-of-domain visual content filtered from the retrieved visual content through the user interface 302 in response to user-controlled filtering of unwanted visual content, for example, as shown in FIG. 4. In this example, the user interface module 319 allows users to select objects in the visual content image 400 (e.g., the 3×3 grid) to trigger a search query that would retrieve and display images similar to the ones selected. In various aspects of the present disclosure, the user interface module 319 enables the user to specify a region 420 within the bounding box 410 that should be included or ignored in the search. For example, lassoing around a vent alone to specify the region 420, instead of the entire component that includes the control wheel 430 should trigger a search for the vent, effectively acting as a visual search filter. Optionally, the user interface module 319 (e.g., in case the detected objects in an image do not correspond to the designer's object of interest) enables specifying and selecting a customized region (e.g., lasso) in the visual concept for which the designer intends to retrieve relevant out-of-domain inspirational content.

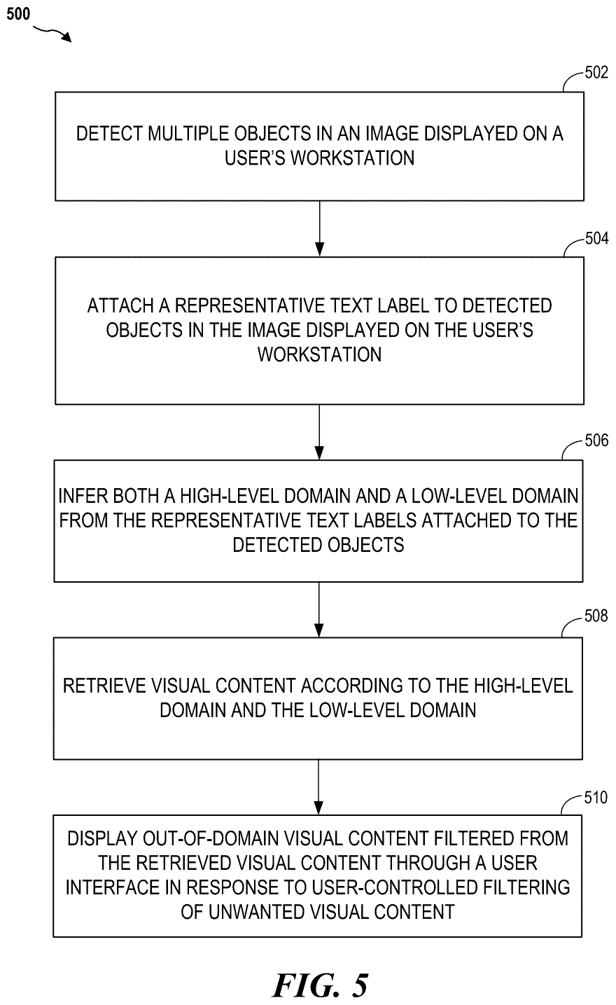

FIG. 5 is a process flow diagram illustrating a method 500 for a content creation system, according to aspects of the present disclosure. The method 500 begins at block 502, in which multiple objects are detected in an image displayed on a user's workspace. For example, as shown in FIG. 3, the user activity module 310 includes the image/object detection module 312 configured to detect multiple objects in an image displayed on a user's workspace. In some aspects of the present disclosure, the image/object detection module 312 uses the OCR 330 and the NLP 340 to determine images displayed on the user's workspace through the user interface 302. In some aspects of the present disclosure, the image/object detection module 312 assesses content accessed by the user to determine a content of the image and objects displayed on the user's workspace, such as the visual content image 400 shown in FIG. 4.

At block 504, a representative text label is attached to detected objects in the image displayed on the user's workspace. For example, as shown in FIG. 3, the user activity module 310 includes an object labeling module 314 configured to attach a representative text label for each detected object in an image displayed on the user's workspace. In some aspects of the present disclosure, the object labeling module 314 includes a labeling model 315 that detects multiple objects in a given image, then attaches a representative text label for each detected object. In some aspects of the present disclosure, the labeling model 315 is trained to provide a text-image joint embedding to enable object identification and/or text label assignment. In some aspects of the present disclosure, bounding boxes and/or unique boundaries are drawn around the detected objects in the image displayed on the user's workspace and/or displayed through the user interface 302, for example, as shown in FIG. 4.

At block 506, both a high-level domain and a low-level domain are inferred from the representative text labels attached to the detected objects. For example, as shown in FIG. 3, the label domain inference module 316 is configured to infer both a high-level domain and a low-level domain from the representative text labels attached to the detected objects of the image. For example, the label domain inference module 316 may infer a high-level domain (e.g., automotive, fashion, architecture, etc.) and a low-level domain (e.g., automotive interior, automotive exterior) from the representative text label by looking at higher-level words from a lexical ontology. In some aspects of the present disclosure, the labeling model 315 uses a tuned natural language processing algorithm (e.g., using the NLP 340) to determine higher-level words from a lexical ontology of content displayed on the user's workspace. The label domain inference module 316 may be implemented using a tuned natural language processing algorithm, such as a lexical ontology approach and/or sentiment analysis.

At block 508, visual content is retrieved according to the high-level domain and the low-level domain. For example, as shown in FIG. 3, the visual content retrieval module 318 that is configured to retrieve visual content according to the high-level domain and the low-level domain. In some aspects of the present disclosure, the visual content retrieval module 318 is implemented using a search engine that retrieves and displays visual content (e.g., in a 3×3 grid) based on perceptual and functional similarity to the target image specified by a user. For example, selecting an A/C vent bounding box in an image of a car's interior by the user could trigger a search engine to retrieve and display similar out-of-domain examples that serve the purpose of an air vent and also resemble the physical appearance of a vent used for other purposes (e.g., sunshade—from home interior domain), as shown in FIG. 4.

At block 510, out-of-domain visual content filtered from the retrieved visual content through a user interface is displayed in response to user-controlled filtering of unwanted visual content. For example, as shown in FIG. 3, the user interface module 319 is configured for filtering and specifying desired visual content via text. For example, the user interface module may display word tags representing different domains (e.g., aerospace, automotive, etc.) derived from the text-image joint embedding with the images using the label domain inference module 316. Additionally, the user interface module 319 enables users to turn off certain word tags to filter unwanted inspirations. The user interface module 319 also includes a filter for specifying whether the users want to see functionally or perceptually relevant visual content, for example, as shown in FIG. 4.

The method 500 includes retrieval of the visual content by searching for visual content images between the high-level domain and the low-level domain, using a search engine. The method 500 further includes displaying, through the user interface, a first visual content image. The method 500 also includes detecting a target image in specified by the user from the visual content image. The method 500 further includes displaying a second visual content image retrieved by a search engine based on a perceptual and functional similarity to the target image specified by the user. The method 500 includes displaying, through the user interface, visual content images. The method 500 also includes detecting user-controlled filtering of unwanted visual content from the visual content images. The method 500 further includes displaying out-of-domain visual content filtered from the visual content retrieved through the user interface in response to the detecting of user-controlled filtering of unwanted visual content. The method 500 includes displaying, through the user interface, a first visual content image including the detected objects represented in bounding boxes. The method 500 also includes detecting user selection of objects in the bounding boxes. The method 500 further includes displaying a second visual content image retrieved by a search engine based on a perceptual and functional similarity to the user selected objects. The method 500 also includes the user interface configured to enable the user to specify a region in the bounding boxes to include/exclude in a search by the search engine.

Some aspects of the present disclosure are directed to addressing a desire for adaptive visual inspiration generation tools that retrieve and display functionally and perceptually similar visual content that correspond to designers' specified scope in an image content within their workspace. In various aspects of the present disclosure, a visual content creation system detects multiple objects in a given image, attaches a representative text label, and infers a high-level domain (e.g., automotive, fashion, architecture, etc.) and a low-level domain (e.g., automotive interior, automotive exterior) from the representative text label by looking at higher-level words from a lexical ontology as discussed above. This content creation system provides an interface that enables users to turn off certain word tags to filter unwanted inspirations.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM, flash memory, ROM, programmable read-only memory (PROM), EPROM, EEPROM, registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in several ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more FPGAs, PLDs, controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method for visual content search and creation, comprising:
detecting multiple objects in an image displayed on a user's workspace;
attaching a representative text label to detected objects in the image displayed on a user's workspace;
inferring both a high-level domain and a low-level domain from the representative text labels attached to the detected objects;
displaying, through a user interface, initial visual content retrieved according to the high-level domain and the low-level domain including the detected objects represented in bounding boxes and/or unique boundaries of each detected object;
detecting a dynamic, user-controlled selection of a customized region in a bounding box and/or unique boundaries of a detected object in the initial visual content;
detecting an unidentified object selected by the user in the customized region of the initial visual content; and
displaying, through the user interface, retrieved, out-of-domain visual content retrieved by a search engine based on a perceptual and functional similarity to the unidentified object selected by the user in the customized region of the initial visual content.

2. The method of claim 1, in which identifying the multiple objects comprises automatically recognizing the multiple objects in the image displayed on the user's workspace using computer vision based object detection and instance segmentation and/or a natural language processor.

3. The method of claim 1, in attaching the representative text labels comprises using an optical character recognition (OCR) block and/or a natural language processor (NLP) to attach the representative text label to the detected objects in the image displayed on the user's workspace.

4. The method of claim 1, in which retrieving the visual content comprises searching for visual content images between the high-level domain and the low-level domain, using a search engine.

5. The method of claim 1, in which displaying comprises:
displaying, through the user interface, a first visual content image;
detecting a target image specified by the user from the first visual content image; and
displaying a second visual content image retrieved by a search engine based on a perceptual and functional similarity to the target image specified by the user.

6-7. (canceled)

8. The method of claim 1, in which the user interface enables the user to specify a region in the bounding boxes and/or unique boundaries of each object to include/exclude in a search by the search engine.

9. A non-transitory computer-readable medium having program code recorded thereon for a visual content search and creation, the program code being executed by a processor and comprising:
program code to detect multiple objects in an image displayed on a user's workspace;
program code to attach a representative text label to detected objects in the image displayed on the user's workspace;
program code to infer both a high-level domain and a low-level domain from the representative text labels attached to the detected objects;
program code to display, through a user interface, initial visual content retrieved according to the high-level domain and the low-level domain including the detected objects represented in bounding boxes and/or unique boundaries of each detected object;
program code to detect a dynamic, user-controlled selection of a customized region in a bounding box and/or unique boundaries of a detected object in the initial visual content;
program code to detect an unidentified object selected by the user in the customized region of the initial visual content; and
program code to display, through the user interface, retrieved, out-of-domain visual content retrieved by a search engine based on a perceptual and functional similarity to the unidentified object selected by the user in the customized region of the initial visual content.

10. The non-transitory computer-readable medium of claim 9, in which the program code to identify the multiple objects comprises program code to automatically recognize the multiple objects displayed on the user's workspace using computer vision based object detection and instance segmentation and/or a natural language processor.

11. The non-transitory computer-readable medium of claim 9, in the program code to attach the representative text labels comprises using an optical character recognition (OCR) block and/or a natural language processor (NLP) to attach the representative text label to the detected objects in the image displayed on the user's workspace.

12. The non-transitory computer-readable medium of claim 9, in which the program code to retrieve the visual content comprises program code to search for visual content images between the high-level domain and the low-level domain, using a search engine.

13. The non-transitory computer-readable medium of claim 9, in which the program code to display comprises:
program code to display, through the user interface, a first visual content image;
program code to detect a target image specified by the user from the first visual content image; and
program code to display a second visual content image retrieved by a search engine based on a perceptual and functional similarity to the target image specified by the user.

14-15. (canceled)

16. The non-transitory computer-readable medium of claim 9, in which the user interface enables the user to specify a region in the bounding boxes and/or the unique boundaries of each object to include/exclude in a search by the search engine.

17. A system for a visual content creation, the system comprising:
an image/object detection module to detect multiple objects in an image displayed on a user's workspace;
an object labeling module to attach a representative text label to detected objects in the image displayed on the user's workspace;
a label domain inference module to infer both a high-level domain and a low-level domain from the representative text labels attached to the detected objects;
a visual content retrieval module to display, through a user interface, an initial visual content retrieved according to the high-level domain and the low-level domain including the detected objects represented in bounding boxes and/or unique boundaries of each detected object, to detect a dynamic, user-controlled selection of a customized region of the initial visual content, and to detect an unidentified object selected by the user in the customized region of the initial visual content; and
a display device to display, through the user interface, retrieved, out-of-domain visual content retrieved by a search engine based on a perceptual and functional similarity to the unidentified object selected by the user in the customized region of the initial visual content.

18. The system of claim 17, in the object labeling module comprises a computer vision based object detection and instance segmentation model and/or a natural language processor (NLP) to attach the representative text label to the detected objects in the image displayed on the user's workspace.

19. The system of claim 17, in which the visual content retrieval module is further to search for visual content images between the high-level domain and the low-level domain, using a search engine.

20. The system of claim 17, in which a user interface enables the user to specify a region in the bounding boxes and/or the unique boundaries of each object to include/exclude in a search by a search engine.
